(19) United States
(12) Patent Application Publication
(10) Pub. No.: US 2013/0067661 A1
(43) Pub. Date: Mar. 21, 2013

(54) Dry Air Patient Support System and Method

(71) Applicants: Jay Schwirian, Monongahela, PA (US); Tushcr Shah, Newtown Square, PA (US); Bradley Yakam, New Albany, OH (US); Andrew Schwirian, Pittsburgh, PA (US)

(72) Inventors: Jay Schwirian, Monongahela, PA (US); Tushcr Shah, Newtown Square, PA (US); Bradley Yakam, New Albany, OH (US); Andrew Schwirian, Pittsburgh, PA (US)

(73) Assignee: AMERICAN HOME HEALTH CARE, INC., Westerville, OH (US)

(21) Appl. No.: 13/417,449

(22) Filed: Mar. 12, 2012

Related U.S. Application Data
(60) Provisional application No. 61/451,319, filed on Mar. 10, 2011.

(51) Int. Cl. A61G 7/05; B01D 53/04

(52) U.S. Cl. CPC A61G 7/05; B01D 53/04
USPC 5/600; 96/118

(57) ABSTRACT

A patient support system and related method are provided to remove moisture away from a patient and into an interior of a patient support surface. Dry air is circulated through the interior of the support surface to draw away the moisture. Air movers and air dryers are used to circulate and recondition the air in a closed flow path through the patient support surface and back into the air movers and dryers. Alternatively, environmental air may be dried and propelled by the air movers and dryers through the interior of the support surface and discharged back into the environment.

### CROSS-REFERENCE TO RELATED APPLICATION

This application claims the benefit of U.S. Provisional Application No. 61/451,319, filed Mar. 10, 2011, which is hereby incorporated by reference.

### BACKGROUND

The present disclosure includes, inter alia, patient support systems that may be configured to utilize dry air to remove moisture from the patient interface and/or from within the support surface. Example embodiments may include closed circuit air flow arrangements and/or open circuit air flow arrangements.

### SUMMARY

The present disclosure contemplates that some low air loss support systems may utilize high volumes of air flow to maintain inflation of support surfaces and/or to provide bleed air for moisture management. In some systems, air may be forced upwards through a top sheet of the support surface, which may encourage evaporation of moisture from around a patient lying on the support surface. However, such systems may not effectively remove moisture from areas where the patient's body may at least partially obstruct air flow upward through the top cover.

The present disclosure contemplates that some support surface systems may be configured to use a source of positive pressure (e.g., “push” configurations) and/or a source of negative pressure (e.g., “pull” configurations) to move air through certain portions of the support surface. See, e.g., U.S. Patent Application Publication No. 2007/0261548, which is incorporated by reference. Some systems may utilize air flow upward (generally in the manner of the low air loss systems mentioned above) or downward through the top sheet of the support surface to remove moisture from around the patient. Other systems may rely on the transfer of moisture downward through a vapor-permeable but generally air-impermeable top sheet. Such systems may flow air through the support surface generally along an underside of the vapor-permeable top sheet in an effort to remove moisture.

The present disclosure contemplates that, because the systems described above utilize substantially unconditioned air from the surrounding environment, the moisture-removal effectiveness of the systems may depend upon the characteristics (e.g., relative humidity) of the air in the surrounding environment. Generally, air having a higher relative humidity will be capable of removing less moisture than air having a lower relative humidity. The present disclosure contemplates that conditioned spaces within buildings may contain air with a relative humidity of about fifty percent.

As used herein, dry air may refer to air having a relative humidity less than the relative humidity of the surrounding environment. As used herein, dry air does not necessarily imply that the air contains no moisture or substantially no moisture. For example, dry air may be produced by subjecting air to the action of an air dryer, such as a dehumidifier and/or a desiccant, which may reduce the amount of moisture in the air.

The present disclosure contemplates that mechanical/refrigerative dehumidifiers may operate by drawing moist air over a refrigerated coil. Water from the moist air may condense on the coil and may be collected or directed away. The present disclosure contemplates that electronic dehumidifiers may use a peltier heat pump to generate a cool surface for condensing water vapor from the air. Electronic dehumidifiers may be very quiet and/or may avoid the use of a mechanical compressor.

The present disclosure contemplates that a desiccant may be a hygroscopic substance that induces or sustains a state of dryness (desiccation) in its local vicinity. Some desiccants may be solids and/or may work through absorption or adsorption of water, or a combination of absorption and adsorption. Example desiccants may comprise silica gel, activated alumina, molecular sieve (crystalline aluminosilicates) 3A-13A mesh, montmorillonite clay, calcium oxide, and/or calcium sulfate. Example desiccants may comprise powders, granules (e.g., about 1.0 mm to about 6.0 mm), pellets, and/or beads (e.g., about 0.5 mm to about 8 mm).

Some example embodiments may have a closed circuit configuration, which may describe systems in which there may be little or substantially no air exchange between an internal volume of a support surface and the surrounding environment (e.g., room air). In other words, a closed circuit configuration may recirculate air through the internal volume of the support surface. Some example embodiments according to the present disclosure may have an open circuit configuration, which may describe systems in which air utilized by the system may be drawn from and/or discharged to the surrounding environment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example patient support system, including a closed circuit air flow path, of the present invention;

FIG. 2 is a block diagram illustrating an alternate embodiment of the patient system, including an open circuit air flow path, of the present invention;

FIG. 3 is a block diagram illustrating an embodiment of the patient support system of the present invention having an alternate open circuit air flow path;

FIG. 4 is a cross-sectional view of an air dryer embodiment;

FIG. 5 is a perspective view of an embodiment of a support surface adapted for use with an air mover and an air dryer;

FIG. 6 is a block diagram of an example of a control system for use with at least some embodiments of the present invention; and

FIG. 7 is a block diagram of an example computing environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the figures, may be arranged, substituted, combined, and designed in a wide variety of different configurations, all of which are explicitly contemplated and make part of this disclosure.

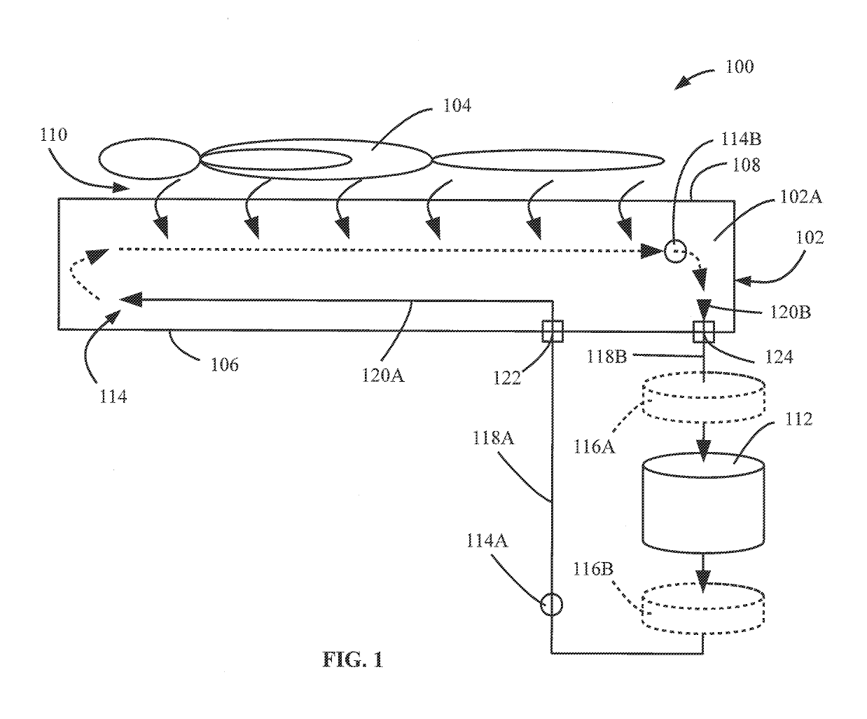

FIG. 1 is a block diagram illustrating an example support system including a closed circuit air flow path. Example support system 100 may include a support surface 102 (e.g., a mattress) for receiving a patient 104. Example support surfaces 102 may include any components known in the art, such as inflatable sections and foam portions.

Support surface 102 may include a cover 106 at least partially enclosing at least a portion of support surface 102. In some example embodiments, cover 106 may substantially enclose support surface 102. At least some portions of cover 106 may be constructed from one or more materials that limit air exchange between an interior 102A of support surface 102 and the surrounding environment. Support surface 102 may include a top sheet 108, which may comprise a portion of cover 106. Top sheet 108 may be constructed of a vapor-permeable material which may substantially restrict the flow of air therethrough. In some example embodiments, moisture 110 proximate patient 104 may transfer through top sheet 108 into interior 102A of support surface 102.

In some example embodiments, an air mover 112 may be configured to propel air in a closed circuit air flow path 114 including at least a portion of interior 102A of support surface 102. Air movers 112 may include, for example and without limitation, blowers, fans, pumps, vacuum units, and/or the like. At least one air dryer 116A, 116B may be provided in air flow path 114 and/or may be configured to remove moisture from air flowing in closed circuit air flow path 114. Air dryers 116A, 116B may include, for example and without limitation, one or more desiccants and/or dehumidifiers. One or more air dryers 116A may be provided upstream of air mover 112 in air flow path 114 and/or one or more air dryers 116B may be provided downstream of air mover 112 in air flow path 114. In some example embodiments, one or more of air dryers 116A, 116B may be provided integrally with air mover 112. In some example embodiments, one or more of air dryers 116A, 116B may be provided as a readily replaceable, modular component, such as a cartridge and/or a canister, that may be selectively installed into and/or removed from air flow path 114 and/or which may include appropriate couplings and/or fittings.

In some example embodiments, air flow path 114 may include one or more conduits 118A, 118B, 120A, 120B, which may be arranged to direct air flow between various elements, such as air mover 112, air dryers 116A, 116B, and/or interior 102A of support surface 102. For example, exterior conduits 118A, 118B may be arranged to substantially contain and/or direct air flow in portions of air flow path 114 that may be outside of support surface 102. Similarly, interior conduits 120A, 120B may be arranged to substantially contain and/or direct air flow in portions of air flow path 114 that may be within interior 102A of support surface 102. Conduits 118A, 118B, 120A, 120B may be releaseably and/or permanently operatively coupled using fittings 122, 124. In some example embodiments, fitting 122 and/or fitting 124 may include quick-disconnect type fittings.

Some example embodiments may include one or more humidity sensors configured to sense the humidity at one or more places in air flow path 114. For example, humidity sensor 114A may be configured to sense humidity in air flow path 114 within conduit 118A. As another example, humidity sensor 114B may be configured to sense humidity in air flow path 114 within interior 102A of support surface 102.

An example support system 100 as shown in FIG. 1 may operate as follows. Air may be circulated around air flow path 114 by air mover 112. For example, air mover 112 may push air through air dryer 116B, through exterior conduit 118A, through fitting 122, through interior conduit 120A and into interior 102A of support surface 102. The air may flow from generally near the head end of support surface 102 to generally near the foot end of support surface 102, where it may flow through interior conduit 120B and out support surface 102 through fitting 124. Fitting 124 may be coupled to exterior conduit 118B, which may direct the air flow to air mover 112 via air dryer 116A. Air dryers 116A, 116B may operate to remove moisture from the recirculated air, such as by drying the air through the use of a desiccant present within air dryers 116A, 116B. Thus, the recirculated air may have a low relative humidity, such as about ten percent.

Moisture 110 emitted by patient 104 may diffuse through top sheet 108 (which may act as a semi-permeable membrane) because the air beneath top sheet 108 may have a substantially lower relative humidity than air, skin, sheets, etc. immediately above top sheet 108. In other words, moisture 110 may move from an area of higher concentration to an area of lower concentration. Moisture 110 that diffuses downward through top sheet 108 may be carried by the flowing air to air dryers 116A, 116B, where the moisture may be removed from the air, and the air may continue to be recirculated.

In some example embodiments, air mover 112 may be substantially smaller (in size and/or capacity) and/or quieter than blowers associated with low air loss mattresses. For example, air mover 112 may comprise a fan generally similar to those used in personal computers. Further, the amount of heat generated by relatively small air movers 112 may be substantially less than the amount of heat produced by larger air movers, such as blowers associated with conventional air loss mattresses.

The present disclosure contemplates that recirculating air within closed circuit flow path 114 may allow the creation and/or maintenance of a microclimate in interior 102A of support surface 102. Because the microclimate may be at least partially isolated from the surrounding environment, the humidity of the air in the surrounding environment may have a limited effect on the humidity within the microclimate. Some example embodiments may enable creation and/or maintenance of a microclimate containing air have a substantially lower relative humidity (e.g., less than about ten percent) even when the surrounding environment has a much higher relative humidity (e.g., in excess of about fifty percent).

The present disclosure contemplates that many bacteria, fungi, and/or other organisms may not be able to survive and/or thrive in an environment having a low relative humidity. For example, many undesirable organisms may not be able to live in an environment having less than about ten percent relative humidity. Accordingly, drying the microclimate in interior 102A of support surface 102 may reduce and/or eliminate issues associated with undesirable organisms. For example, odors associated with some organisms that typically grow in moist areas may be prevented, reduced, and/or eliminated from within interior 102A of support surface 202A by recirculating dry air therein.

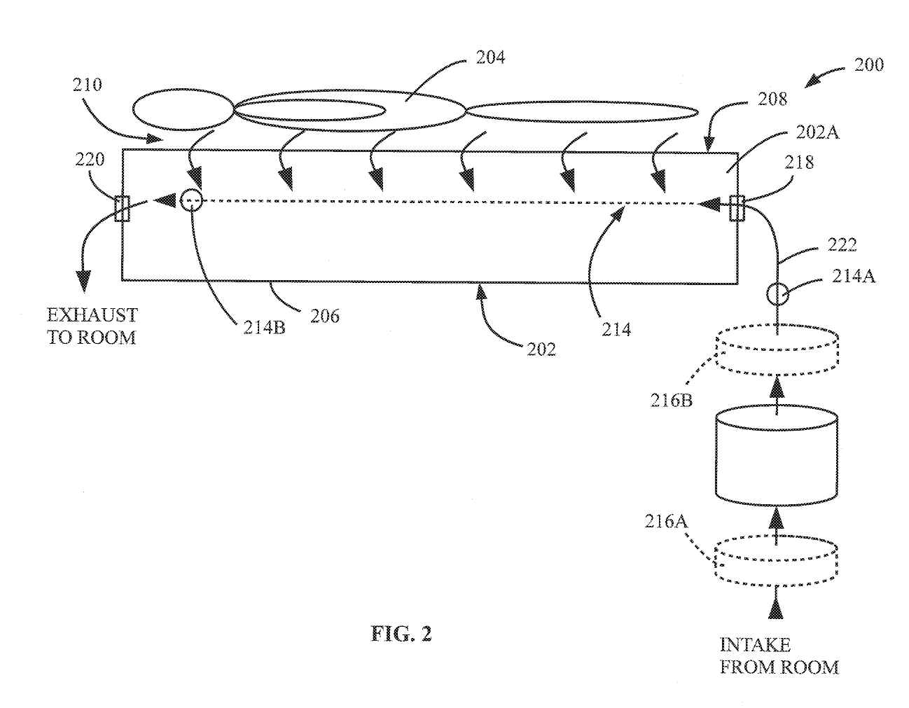

FIG. 2 is a block diagram illustrating an example support system including an open circuit air flow path. An example support system 200 may include a support surface 202 for receiving a patient 204. Support surface 202 may include a cover 206 at least partially enclosing at least a portion of support surface 202. Support surface 202 may include a top sheet 208, which may comprise a portion of cover 206. Top sheet 208 may be constructed of a vapor-permeable material. In some example embodiments, moisture 210 proximate patient 204 may transfer through top sheet 208 into interior 202A of support surface 202.

In some example embodiments, an air mover 212 may be configured to propel air in an open circuit air flow path 214 including at least a portion of interior 202A of support surface 202. At least one air dryer 216A, 216B may be provided in air flow path 214 and/or may be configured to remove moisture from air flowing through open circuit air flow path 214. One or more air dryers 216A may be provided upstream of air mover 212 in air flow path 214 and/or one or more air dryers 216B may be provided downstream of air mover 212 in air flow path 214.

The example support system 200 shown in FIG. 2 may be configured to “push” air from air mover 212 through internal volume 202A of support surface 202. Room air may flow from the surrounding environment, through air mover 212, through support system 202, and back into the surrounding environment. Air mover 212 may be operatively coupled to support surface 202 using one or more fittings 218 and/or an exterior conduit 222. Air may be discharged from support surface 202 into the surrounding environment via one or more openings 220 which may be provided in support surface 202.

Some example embodiments may include one or more humidity sensors configured to sense the humidity at one or more places in air flow path 214. For example, humidity sensor 214A may be configured to sense humidity in air flow path 214 within conduit 222. As another example, humidity sensor 214B may be configured to sense humidity in air flow path 214 within interior 202A of support surface 202.

An example support system 200 as shown in FIG. 2 may operate as follows. Air may be propelled through air flow path 214 by air mover 212. For example, air mover 212 may draw air through air dryer 216A and into air mover 212. Air mover 212 may discharge the air through air dryer 216B and/or into interior 202A of support surface 202 via exterior conduit 222 and/or fitting 218. The air may flow from generally near the foot end of support surface 202 to generally near the head end of support surface 202, where it may flow out into the surrounding environment via opening 220. Air dryers 216A, 216B may operate to remove moisture from the flowing air, such as by drying the air through the use of a desiccant present within air dryers 216A, 216B. Thus, the air in air flow path 214 may have a low relative humidity, such as about ten percent.

Moisture 210 emitted by patient 204 may diffuse through top sheet 208 (which may act as a semi-permeable membrane) because the air beneath top sheet 208 may have a substantially lower relative humidity than air, skin, sheets, etc. immediately above top sheet 208. In other words, moisture 210 may move from an area of higher concentration to an area of lower concentration. Moisture 210 that diffuses downward through top sheet 208 may be carried by the flowing air to out of support surface 202 and into the environment surrounding support surface 202.

The present disclosure contemplates that drying the air flowing through open circuit flow path 214 before it enters support surface 202 may allow the creation and/or maintenance of a microclimate in interior 202A of support surface 202. For example, the microclimate may have a substantially lower relative humidity (e.g., less than about ten percent) even when the surrounding environment has a much higher relative humidity (e.g., in excess of about fifty percent).

In some example embodiments, air mover 112 and/or one or more of air dryers 116A, 116B may be disposed at least partially within interior 102A of support surface 102 and/or within a cavity provided at least partially within support surface 102, which may be outside of interior 102A of support surface 102.

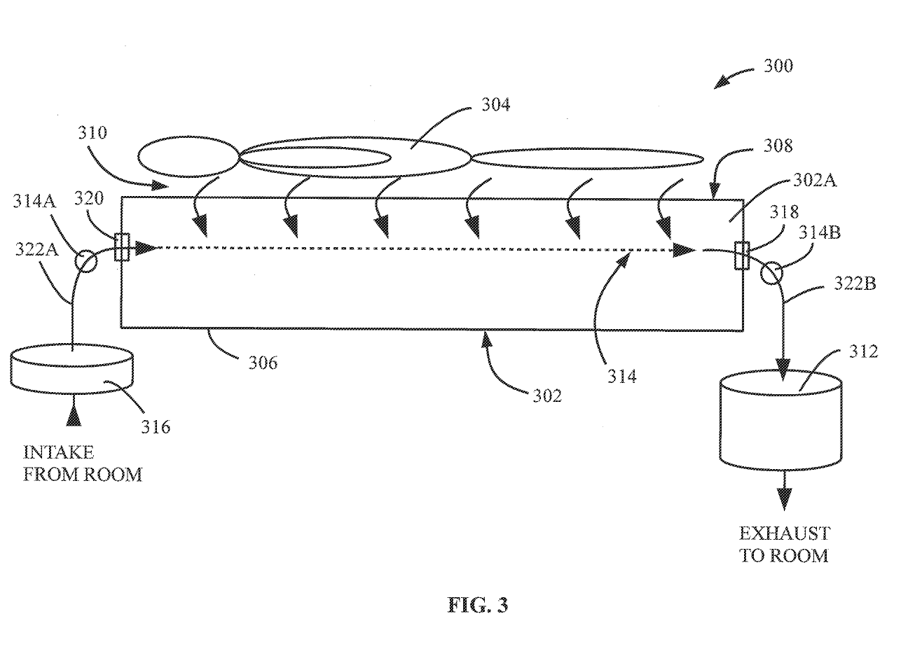

FIG. 3 is a block diagram illustrating an example support system including an alternate open circuit air flow path. An example support system 300 may include a support surface 302 for receiving a patient 304. Support surface 302 may include a cover 306 at least partially enclosing at least a portion of support surface 302. Support surface 302 may include a top sheet 308, which may comprise a portion of cover 306. Top sheet 308 may be constructed of a vapor-permeable material. In some example embodiments, moisture 310 proximate patient 304 may transfer through top sheet 308 into interior 302A of support surface 302.

In some example embodiments, an air mover 312 may be configured to propel air in an open circuit air flow path 314 including at least a portion of interior 302A of support surface 302. At least one air dryer 316 may be provided in air flow path 314 and/or may be configured to remove moisture from air flowing through open circuit air flow path 314. For example, air dryer 316 may be provided upstream of support surface 302 in air flow path 314.

The example support system 300 shown in FIG. 3 may be configured to “pull” air through internal volume 302A of support surface 302 using air mover 312. Air mover 312 may be operatively coupled to support surface 302 using one or more fittings 318 and/or exterior conduit 322B. Air may be drawn into support surface 202 from air dryer 316 through one or more fittings 320 and/or exterior conduit 322A.

Some example embodiments may include one or more humidity sensors configured to sense the humidity at one or more places in air flow path 314. For example, humidity sensor 314A may be configured to sense humidity in air flow path 314 within conduit 322A. As another example, humidity sensor 314B may be configured to sense humidity in air flow path 314 within conduit 322B.

An example support system 300 as shown in FIG. 3 may operate as follows. Air may be propelled through air flow path 314 by air mover 312. For example, air mover 312 may draw air through air dryer 316, into interior 302A of support surface 302 (e.g., via exterior conduit 322A and/or fitting 320), through interior 302A, and/or into air mover 312 (e.g., via fitting 318 and/or exterior conduit 322B). The air may flow from generally near the head end of support surface 302 to generally near the foot end of support surface 302. Air mover 312 may discharge the air into the surrounding environment. Air dryer 316 may operate to remove moisture from the flowing air, such as by drying the air through the use of a desiccant present within air dryer 316. Thus, the air in air flow path 314 may have a low relative humidity, such as about ten percent.

Moisture 310 emitted by patient 304 may diffuse through top sheet 308 (which may act as a semi-permeable membrane) because the air beneath top sheet 308 may have a substantially lower relative humidity than air, skin, sheets, etc. immediately above top sheet 308. In other words, moisture 310 may move from an area of higher concentration to an area of lower concentration. Moisture 310 that diffuses downward through top sheet 308 may be carried by the flowing air to out of support surface 302 and into the environment surrounding support surface 302.

The present disclosure contemplates that drying the air flowing through open circuit flow path 314 before it enters support surface 302 may allow the creation and/or maintenance of a microclimate in interior 302A of support surface 302. For example, the microclimate may have a substantially lower relative humidity (e.g., less than about ten percent) even when the surrounding environment has a much higher relative humidity (e.g., in excess of about fifty percent).

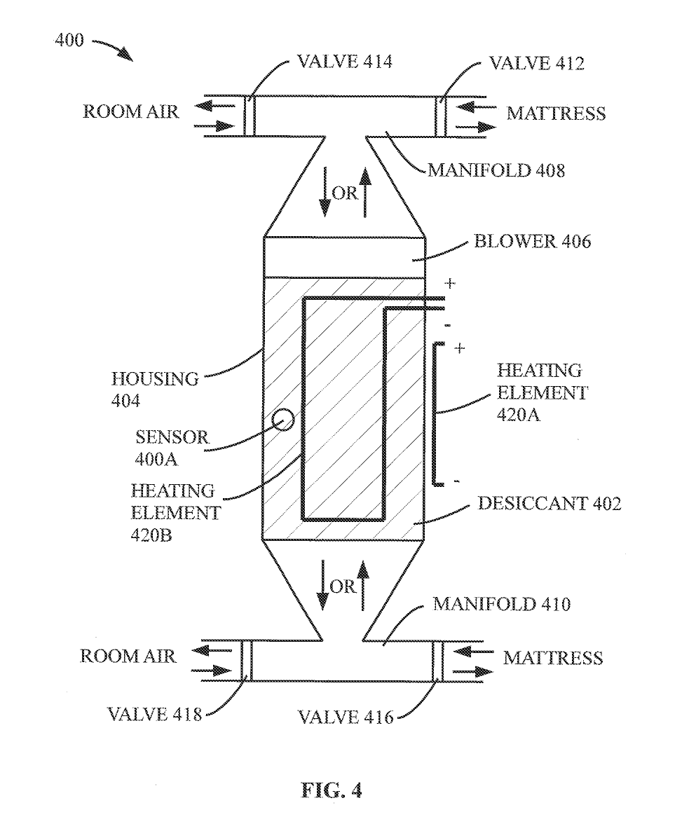

FIG. 4 is a cross-sectional view of an example air dryer. An air dryer 400 may include a desiccant 402 disposed in a housing 404. In some example embodiments, an air mover, such as blower 406, may be provided in housing 404 and/or may be arranged to cause air flow through desiccant 402. Housing 404 may be provided with one or more manifolds 408, 410 (e.g., at each end) such that air may be flowed through desiccant 402.

In some example embodiments, one or more of manifolds 408, 410 may include one or more valves 412, 414, 416, 418 for directing air flow as desired. For example, manifold 408 may include a valve 412 interposing desiccant 402 and the interior volume of a support surface (“mattress”). Manifold 410 may include a similar valve 416. Manifold 408 may include a valve 414 interposing desiccant 402 and a vent to the surrounding environment (“room air”). Manifold 410 may include a similar valve 418. In some example embodiments, one or more of valves 412, 414, 416, 418 may be electrically operated (e.g., solenoid-operated valves).

Some example embodiments may include one or more sensors 400A, which may be configured to detect certain characteristics of desiccant 402. For example, sensor 400A may comprise a humidity sensor that may be configured to detect a moisture content of desiccant. As another example, sensor 400A may comprise an optical sensor configured to detect a color of desiccant 402. In some example embodiments, desiccant 402 may vary in color as its moisture content changes; thus, an optical sensor configured to detect the color of desiccant 402 may be used to ascertain a moisture content of desiccant.

In an example embodiment, a closed circuit air flow path through a mattress may be provided by shutting valves 414, 418 and by opening valves 412, 416. In such a configuration, blower 406 may draw air from the mattress via valve 412, direct the air through desiccant 402, and return the air to the mattress via valve 416.

Air dryer 400 may be configured for in-place desiccant regeneration. For example, housing 404 may include one or more heating elements 420A, 420B arranged to heat desiccant 402. An example heating element 420A may be provided externally, such that it may heat desiccant 402 through housing 404. An example heating element 420B may be provided internally. Example heating elements 420A, 420B may include electro-resistive heating elements.

During an example desiccant regeneration operation, valve 412 and/or valve 416 may be shut to block air flow to and/or from the mattress. Valve 414 and/or valve 418 may be opened to vent moisture released from desiccant 402. During some example desiccant regeneration operations, blower 406 and/or another air mover may be operated, such as to flow air from the surrounding environment through desiccant 402 via valves 414, 418. Following a desiccant regeneration operation, valves 412, 414, 416, 418 may be repositioned to provide a closed circuit flow path as described above, for example.

In some example embodiments including replaceable cartridges and/or canisters containing desiccant, the cartridges and/or canisters may be removed and replaced with fresh or regenerated cartridges and/or canisters. The used cartridges and/or canisters may be regenerated (such as by heating the cartridges and/or canisters and/or the desiccant contained there) and reused. In some example embodiments, used desiccant cartridges and/or canisters may be discarded.

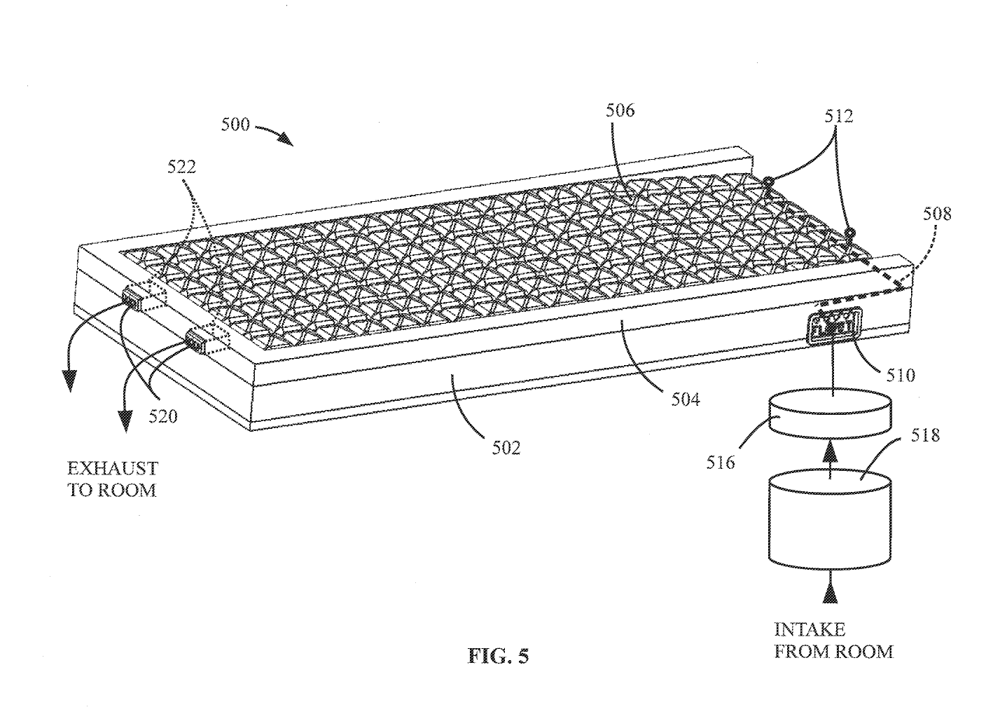

FIG. 5 is a perspective view of an example support surface configured for use with an air mover and an air dryer. Support surface 500 may include a base 502, a bolster 504 (which may include one or more side walls and/or end walls), and one or more inflatable support sections 506 (which may comprise a plurality of fluidly connected, upstanding chambers). Support surface 500 may include a cover as described above; however, FIG. 5 illustrates support surface 500 without the cover installed. One or more internal conduits 508 may direct air from an external connection panel 510 to one or more conduit terminations 512, which may be configured to deliver air into an interior of the support surface. For example, external connection panel 510 may be provided on a side face of support surface 500 near the foot end, and internal conduit 508 may deliver air to two conduit terminations 512 proximate the foot end of the mattress.

External connection panel 510 may be configured to operatively couple internal conduit 508 with an external conduit 514 providing dry air flow from an air dryer 516 and/or an air mover 518. Air may flow through internal conduit 508 and/or may flow into the interior of support surface 500 via conduit terminations 512. The air may flow from near the foot end of the support surface 500 to near the head end of the support surface 500, where it may be vented to the surrounding environment via one or more openings 520. The air may flow around and/or over individual upstanding chambers of inflatable support sections 506. In some example embodiments, openings 520 may comprise substantially rigid frames 522 (e.g., constructed from molded plastic) in fluidic communication with through passages extending through bolster 504.

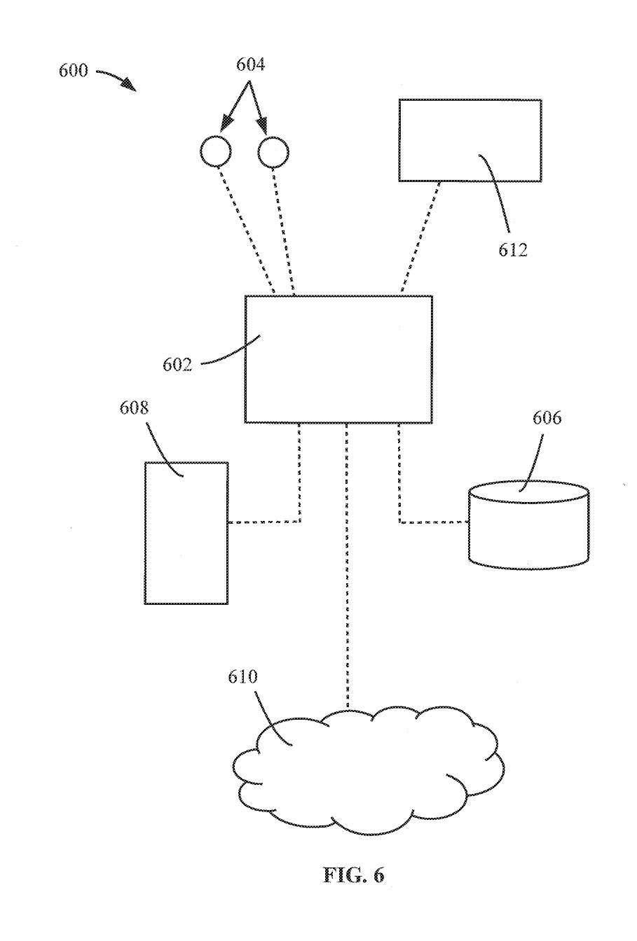

FIG. 6 is a block diagram of an example control system according to at least some embodiments of the present disclosure. Control system 600 may include a controller 602, which may be operatively connected to one or more sensors 604 (e.g., humidity sensors and/or optical sensors as described above), air mover 606 (e.g., blowers, fans, pumps, vacuum units as described above), and/or a desiccant regeneration system 608 (e.g., heating elements and/or valves as described above). In some example embodiments, controller 602 may be operatively connected to a communication network 610 (e.g., an intranet and/or the Internet). Some example controllers 602 may be configured to transmit data pertaining to operation of a support system to one or more remote locations, such as a nurse station, electronic medical records system, and/or central monitoring facility. For example, data associated with operating parameters and/or alarm conditions may be transmitted. In some example embodiments, controller 602 may be configured to receive data via communications network 610. For example, commands associated with operation of regeneration system 608 may be received via communications network 610. Some example embodiments may include an input/output device 612 (e.g., a control panel, touch screen interface, one or more buttons and/or switches, and/or one or more lights and/or indicators). An operator may utilize input/output device 612 to obtain information from controller 602 (e.g., humidity readings) and/or to direct operation of certain components (e.g., air mover 606 and/or regeneration system 608).

In some example embodiments, regeneration of desiccant may be initiated periodically (e.g., daily, weekly, etc.). In some example embodiments, regeneration of desiccant may initiated upon detection of a predetermined condition. For example, detection of a predetermined humidity level by one or more humidity sensors may trigger desiccant regeneration. As another example, detection of a predetermined moisture level of desiccant by an optical sensor may trigger regeneration of the desiccant. Similarly, some embodiments utilizing replaceable desiccant may be configured to notify an operator that the desiccant should be replaced upon detection of one or more predetermined conditions and/or periodically.

Some example embodiments may be configured to regenerate a desiccant by directing relatively dry air through the desiccant. In some example embodiments, the relatively dry air may extract at least some of the moisture captured by the desiccant, thereby regenerating the desiccant. For example, air may be compressed, dried, expanded, and directed through the desiccant. Because the air was dried while compressed and subsequently expanded, it may have a low relatively humidity, thereby allowing it to extract moisture from the desiccant.

Those skilled in the art will recognize that the various aspects of the present disclosure may be implemented in combination with other program modules and/or as a combination of hardware and software.

Generally, program modules include routines, programs, components, data structures, etc., that perform particular tasks or implement particular abstract data types. Moreover, those skilled in the art will appreciate that the methods according to the present disclosure may be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

Some aspects of the present disclosure may also be practiced in distributed computing environments where certain tasks are performed by remote processing devices that are linked through a communications network. In some example distributed computing environments, program modules may be located in local and/or remote memory storage devices.

An example computer may include a variety of computer-readable media. Computer-readable media may include any available media that can be accessed by the computer and includes both volatile and non-volatile media, as well as removable and non-removable media. By way of example, and not limitation, computer-readable media may comprise computer storage media and communication media. Computer storage media may include volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

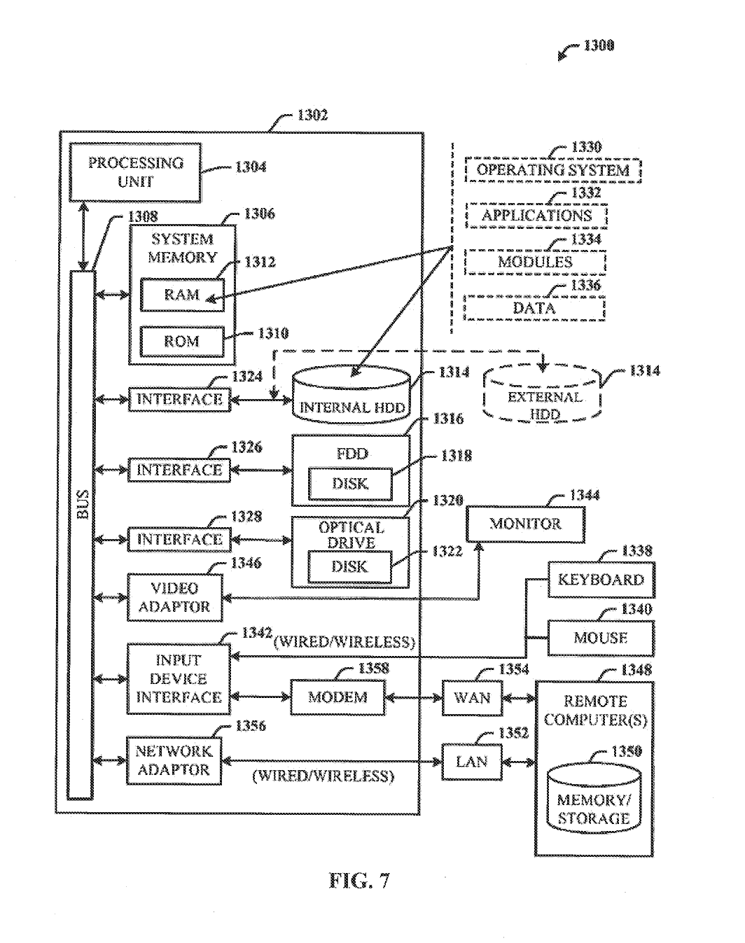

FIG. 7 includes a block diagram of an example computing environment 1300 which may include the controller 602. The computing environment 1300 for implementing various aspects includes a computer 1302, which may include a processing unit 1304, a system memory 1306 and/or a system bus 1308. The system bus 1308 may couple system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structures that may further interconnect to a memory bus (with or without a memory controller), a peripheral bus, and/or a local bus using any of a variety of commercially available bus architectures. The system memory 1306 may include read only memory (ROM) 1310 and/or random access memory (RAM) 1312. A basic input/output system (BIOS) may be stored in a non-volatile memory 1310 such as ROM, EPROM, EEPROM. BIOS may contain basic routines that help to transfer information between elements within the computer 1302, such as during start-up. The RAM 1312 can also include a high-speed RAM such as static RAM for caching data.

The computer 1302 may further include an internal hard disk drive (HDD) 1314 (e.g., EIDE, S ATA), which may also be configured for external use in a suitable chassis, a magnetic floppy disk drive (FDD) 1316 (e.g., to read from or write to a removable diskette 1318), and/or an optical disk drive 1320 (e.g., reading a CD-ROM disk 1322 or, to read from or write to other high capacity optical media such as the DVD). The hard disk drive 1314, magnetic disk drive 1316, and/or optical disk drive 1320 can be connected to the system bus 1308 by a hard disk drive interface 1324, a magnetic disk drive interface 1326, and an optical drive interface 1328, respectively. The interface 1324 for external drive implementations may include at least one or both of Universal Serial Bus (USB) and IEEE 1394 interface technologies. Other external drive connection technologies are within the scope of the disclosure.

The drives and their associated computer-readable media may provide nonvolatile storage of data, data structures, computer-executable instructions, and so forth. For the computer 1302, the drives and media may accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in an example operating environment, and further, that any such media may contain computer-executable instructions.

A number of program modules can be stored in the drives and RAM 1312, including an operating system 1330, one or more application programs 1332, other program modules 1334, and/or program data 1336. All or portions of the operating system, applications, modules, and/or data can also be cached in the RAM 1312. It is to be appreciated that various commercially available operating systems or combinations of operating systems may be utilized.

A user can enter commands and information into the computer 1302 through one or more wired/wireless input devices, e.g., a keyboard 1338 and a pointing device, such as a mouse 1340. Other input devices may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device may also connected to the system bus 1308 via an interface, such as a video adapter 1346. In addition to the monitor 1344, a computer typically includes other peripheral output devices, such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor based entertainment appliance, a peer device, and/or other common network node, and/or may include many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and health care facilities, and facilitate enterprise-wide computer networks, such as intranets, all of which may connect to a global communications network, e.g., the Internet.

When used in a LAN networking environment, the computer 1302 may be connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356.

When used in a WAN networking environment, the computer 1302 can include a modem 1358, or may be connected to a communications server on the WAN 1354, or may have other devices for establishing communications over the WAN 1354, such as by way of the Internet. The modem 1358, which can be internal or external and a wired or wireless device, may be connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag, and/or telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.1 a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can operate in more than one band (e.g., dual band), so the networks can provide real-world performance similar to the basic 10BaseT wired Ethernet networks used in many offices.

All patent, patent application publications, and non-patent literature references mentioned herein are incorporated by reference.

While example embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages of the may exist even though they may not have been explicitly discussed herein.

What is claimed is:

1. A patient support system comprising:
a support structure configured to receive a patient thereon, the support structure comprising a support surface having an interior;
at least one air mover configured to supply and move air through the interior of the support surface; and
at least one air dryer configured to reduce the relative humidity of the supplied air.

2. The patient support system of claim 1, wherein said support surface comprises a cover.

3. The patient support system of claim 2, wherein said cover substantially encloses at least a portion of said support surface.

4. The patient support system of claim 1, wherein said support surface comprises a vapor-permeable material adapted to transfer moisture away from said patient and into said interior of the support surface, and wherein said vapor-permeable material is further adapted to restrict airflow therethrough.

5. The patient support system of claim 4, wherein said at least one air mover is adapted to move air in a closed circuit air flow path, said closed circuit path including at least a portion of said support surface interior.

6. The patient support system of claim 5, wherein said at least one air mover comprises at least one of a blower, a fan, and a pump.

7. The patient support system of claim 5, wherein said at least one air dryer is disposed in said closed circuit air flow path, said at least one air dryer further being adapted to reduce the humidity from air being circulated in said closed circuit air flow path.

8. The patient support system of claim 7, wherein said closed circuit air flow path comprises one or more conduits arranged to direct air flow among said at least one dryer, said at least one air mover, and through said interior of said support surface.

9. The patient support system of claim 8, wherein said at least one air mover is adapted to propel and recirculate air through the interior of said support surface.

10. The patient support system of claim 8, wherein said at least one air mover is adapted to pull and recirculate air through the interior of said support surface.

11. The patient support system of claim 8, wherein said at least one air dryer comprises one or more desiccants adapted to remove moisture from air flowing therethrough.

12. The patient support system of claim 4, wherein said at least one air mover is adapted to move air in an open air flow path from a surrounding environment, through at least a portion of said support surface interior, and back out into the surrounding environment.

13. The patient support system of claim 12, wherein said at least one air mover is adapted to propel and recirculate air through the interior of said support surface.

14. The patient support system of claim 12, wherein said at least one air mover is adapted to pull and recirculate air through the interior of said support surface.

15. The patient support system of claim 11, wherein said at least one air dryer being configured for in-place regeneration of the desiccant.

16. The patient support system of claim 15, wherein said at least one air dryer includes at least one heating element configured to regenerate the desiccant.

17. A patient support system including:
a support surface having an interior;
an air mover configured to recirculate air through the interior of the support surface; and
an air dryer configured to remove moisture from the recirculated air.

18. The patient support system of claim 17, wherein the air mover is configured to draw air from and return air to the interior of the support surface.

19. The patient support system of claim 17, wherein the air dryer is positioned downstream of the air mover.

20. The patient support system of claim 19, wherein the air dryer is positioned upstream of the air mover.

21. The patient support system of claim 17, wherein the air dryer includes at least one of a dehumidifier and a desiccant.

22. The patient support system of claim 17, where the air dryer includes a desiccant.

23. The patient support system of claim 22, where the patient support system is configured to perform in-place regeneration of the desiccant.

24. The patient support system of claim 23, where the air dryer includes at least one heating element arranged to heat the desiccant to regenerate the desiccant.

25. The patient support system of claim 24, where the air mover and the air dryer are provided together within a housing, the housing being fluidly coupled to the interior of the support surface.

26. An air dryer for a patient support system, the air dryer including:
a housing including a desiccant, the housing being configured to allow air flow from a first manifold, through the desiccant, and to a second manifold; and
at least one heating element configured to heat the desiccant during a regeneration operation.

27. A method of supporting a patient, the method including:
transferring moisture from proximate a patient downward through a vapor-permeable top sheet of a support surface into an interior of the support surface;
withdrawing air containing at least some of the moisture from the interior of the support surface;
removing at least some of the moisture from the air; and
redirecting the air into the interior of the support surface.

28. The method of claim 27, wherein the withdrawing and directing operations are performed at least partially by an air mover operatively connected to the interior of the support surface.

29. The method of claim 26, wherein the removing operation is performed at least partially by an air dryer operatively connected to the interior of the support surface.

30. The method of claim 29, wherein the removing operation is performed at least partially by an air dryer including a desiccant.

31. The method of claim 30, further including the step of periodically replacing the desiccant with fresh desiccant.

32. The method of claim 30, further including the step of regenerating the desiccant.

33. The method of claim 32, wherein the regenerating step includes regenerating the desiccant in place by energizing at least one heating element associated with the desiccant.

34. The method of claim 33, further comprising operating at least one valve to vent the desiccant during at least a portion of the regenerating operation.

35. The method of claim 34, further comprising the step of operating at least one valve to separate the desiccant from the interior of the support surface during at least a portion of the regenerating operation.

36. The method of claim 29, wherein the removing operation is performed at least partially by an air dryer including a dehumidifier.

37. The method of claim 27, wherein the steps of withdrawing the air from the interior of the support surface, removing at least some of the moisture from the air, and redirecting the air back into the interior of the support surface are conducted in a substantially closed circuit air flow path.

38. A patient support system including:
a support surface including a vapor-permeable top sheet and an interior at least partially defined by the vapor-permeable top sheet;
an air mover configured to propel air through an air flow path extending from a surrounding environment, through the interior of the support surface, and into the surrounding environment; and
an air dryer operatively positioned in the air flow path upstream of the interior of the support surface, wherein the air dryer is operative to remove at least some moisture from the air in the air flow path prior to the air being delivered to the interior of the support surface.

39. The patient support system of claim 38, wherein the air mover is operatively positioned in the air flow path upstream of the interior of the support surface.

40. The patient support system of claim 38, wherein the air dryer is operatively positioned in the air flow path upstream of the air mover.

41. The patient support system of claim 38, wherein the air dryer is operatively positioned in the air flow path downstream of the air mover.

42. The patient support system of claim 38, where the air mover is operatively positioned within the air flow path downstream of the support surface.

43. The patient support system of claim 22, further comprising a control system configured to periodically regenerate said desiccant.

44. The patient support system of claim 22, further comprising a control system configured to regenerate said desiccant upon detection of a predetermined condition.

45. The patient support system of claim 44, wherein the predetermined condition includes one or more of a humidity level associated with an air flow and a moisture level of the desiccant.

46. The patient support system of claim 45, configured to provide one or more of a local alarm and a remote indication associated with exhaustion of a desiccant.
